(19) United States
(12) Patent Application Publication
(10) Pub. No.: US 2026/0039728 A1
(43) Pub. Date: Feb. 5, 2026

(54) SESSION CONTROL METHOD AND APPARATUS, CHARGING METHOD AND APPARATUS, COMMUNICATION DEVICE, AND STORAGE MEDIUM

(71) Applicants: China Mobile Communication Co., Ltd Research Institute, Beijing (CN); China Mobile Communications Group Co., Ltd., Beijing (CN)

(72) Inventors: Ai CHEN, Beijing (CN); Yi JIANG, Beijing (CN); Bin WEI, Beijing (CN)

(21) Appl. No.: 18/998,285

(22) PCT Filed: Jul. 12, 2023
(86) PCT No.: PCT/CN2023/106958

§ 371 Date: Jan. 24, 2025

(30) Foreign Application Priority Data
Jul. 29, 2022 (CN) 202210909181.4

(51) Int. Cl. H04L 69/322; H04L 65/1069; H04W 84/04

(52) U.S. Cl. CPC H04L 69/322; H04L 65/1069; H04W 84/042

(57) ABSTRACT

This disclosure provides a session control method and apparatus, a charging method and apparatus, a communication device and a readable storage medium, and belongs to the field of communication technology. The session control method includes: a first communication device sends a first request message to a second communication device, the first request message including one or more non-public network identifiers and being used for requesting updating a number-of-sessions for each of the one or more non-public network identifiers; and receives a first response message from the second communication device, wherein the first response message includes first indication information, and the first indication information is used for indicating whether the number-of-sessions for each of the one or more non-public network identifiers reaches a corresponding first value.

### CROSS-REFERENCE TO RELATED APPLICATION

This application claims priority to Chinese Patent Application No. 202210909181.4 filed in China on Jul. 29, 2022, a disclosure of which is incorporated herein by reference in its entirety.

### TECHNICAL FIELD

The present disclosure belongs to the field of communication technology, and specifically relates to a session control method and apparatus, a charging method and apparatus, a communication device, and a readable storage medium.

### BACKGROUND

In the related art, for a non-public network, e.g., Stand-alone Non-Public Network (SNPN) and/or Public Network Integrated Non-Public Network (PNI-NPN), usually only cell-level session control is supported. Therefore, it can be seen that the control granularity of the conventional session control method is relatively large.

### SUMMARY

The purpose of the embodiments of the present disclosure is to provide a session control method and apparatus, a charging method and apparatus, a communication device, and a readable storage medium, to solve the problem of large control granularity of the session control method in the related art.

In order to solve the above technical problem, implementations of the present disclosure are as follows.

In a first aspect, a session control method is provided. The method is performed by a first communication device and includes:
sending a first request message to a second communication device, wherein the first request message includes one or more non-public network identifiers, and is used for requesting updating a number-of-sessions for each of the one or more non-public network identifiers;
receiving a first response message from the second communication device, wherein the first response message includes first indication information, the first indication information is used for indicating whether the number-of-sessions for each of the one or more non-public network identifiers reaches a corresponding first value.

In a second aspect, a session control method is provided. The session control method is performed by a second communication device, and includes:
receiving a first request message from a first communication device, wherein the first request message includes at least one non-public network identifier and is used for requesting updating a number-of-sessions for each of the one or more non-public network identifiers;
checking whether the number-of-sessions for each of the one or more non-public network identifiers reaches a corresponding first value, and updating the number-of-sessions for the non-public network identifier that does not reach the corresponding first value;
sending a first response message to the first communication device, wherein the first response message includes first indication information, the first indication information is used for indicating whether the number-of-sessions for each of the one or more non-public network identifiers reaches the corresponding first value.

In a third aspect, a charging method is provided. The charging method is performed by a seventh communication device, and includes:
in a case that a number-of-sessions for a first non-public network identifier reaches a corresponding first value or a second value, sending a third request message to a fifth communication device, the third request message being used for reporting the number-of-sessions for the first non-public network identifier to enable the fifth communication device to perform a charging processing based on the number-of-sessions for the first non-public network identifier, the first value being a maximum number-of-sessions for the first non-public network identifier, the first value being greater than the second value, and the second value being any one of thresholds of number-of-sessions for the first non-public network identifier;
receiving a fourth response message from the fifth communication device.

In a fourth aspect, a charging method is provided. The charging method is performed by a fifth communication device, and includes:
in a case that a number-of-sessions for a first non-public network identifier reaches a corresponding first value or a second value, receiving a third request message from a seventh communication device, the third request message being used for reporting the number-of-sessions for the first non-public network identifier, and performing, by the fifth communication device, a charging processing based on the number-of-sessions for the first non-public network identifier, wherein the first value is a maximum number-of-sessions for the first non-public network identifier, the first value is greater than the second value, and the second value is any one of thresholds of number-of-sessions for the first non-public network identifier;
sending a fourth response message to the seventh communication device.

In a fifth aspect, a session control apparatus is provided. The session control apparatus is applied to a first communication device, and includes:
a first sending module, configured to send a first request message to a second communication device, wherein the first request message includes one or more non-public network identifiers, and is used for requesting updating a number-of-sessions for each of the one or more non-public network identifiers;
a first receiving module, configured to receive a first response message from the second communication device, wherein the first response message includes first indication information, and the first indication information is used for indicating whether the number-of-sessions for each of the one or more non-public network identifiers reaches a corresponding first value.

In a sixth aspect, a session control apparatus is provided. The session control apparatus is applied to a second communication device, and includes:
a third receiving module, configured to receive a first request message from a first communication device, wherein the first request message includes one or more non-public network identifiers and is used for requesting updating a number-of-sessions for each of the one or more non-public network identifiers;
a processing module, configured to check whether the number-of-sessions for each of the one or more non-public network identifiers reaches a corresponding first value, and to update the number-of-sessions for the non-public network identifier that does not reach the corresponding first value;
a third sending module, configured to send a first response message to the first communication device, wherein the first response message includes first indication information, and the first indication information is used for indicating whether the number-of-sessions for each of the one or more non-public network identifiers reaches the corresponding first value.

In a seventh aspect, a charging apparatus is provided. The charging apparatus is applied to a seventh communication device, and includes:
a fifth sending module, configured to send a third request message to a fifth communication device in a case that a number-of-sessions for a first non-public network identifier reaches a corresponding first value or a second value, the third request message being used for reporting the number-of-sessions for the first non-public network identifier to enable the fifth communication device to perform a charging processing based on the number-of-sessions for the first non-public network identifier, wherein the first value is a maximum number-of-sessions for the first non-public network identifier, the first value is greater than the second value, and the second value is any one of thresholds of number-of-sessions for the first non-public network identifier;
a fifth receiving module, configured to receive a fourth response message from the fifth communication device.

In an eighth aspect, a charging apparatus is provided. The charging apparatus is applied to a fifth communication device, and includes:
a sixth receiving module, configured to receive a third request message from a seventh communication device in a case that a number-of-sessions for a first non-public network identifier reaches a corresponding first value or a second value, the third request message being used for reporting the number-of-sessions for the first non-public network identifier, wherein the fifth communication device performs a charging processing based on the number-of-sessions for the first non-public network identifier, the first value is a maximum number-of-sessions for the first non-public network identifier, the first value is greater than the second value, and the second value is any one of thresholds of number-of-sessions for the first non-public network identifier;
a sixth sending module, configured to send a fourth response message to the seventh communication device.

In a ninth aspect, a communication device is provided. The communication device includes a processor, a memory, and a program or instruction stored in the memory and executable on the processor, wherein the program or instruction, when executed by the processor, implements the steps of the method described in the first aspect, or the steps of the method described in the second aspect, or the steps of the method described in the third aspect, or the steps of the method described in the fourth aspect.

In a tenth aspect, a readable storage medium is provided. The readable storage medium stores a program or instruction. When the program or instruction is executed by a processor, the steps of the method described in the first aspect, or the steps of the method described in the second aspect, or the steps of the method described in the third aspect, or the steps of the method described in the fourth aspect are implemented.

In the embodiments of the present disclosure, a first communication device may send a first request message to a second communication device, the first request message including one or more non-public network identifiers and being used for requesting updating a number-of-sessions for each of the one or more non-public network identifiers, and the first communication device receives a first response message from the second communication device, the first response message including first indication information, the first indication information being used for indicating whether the number-of-sessions for each of the one or more non-public network identifiers reaches a corresponding first value. Thus, through the indication as to whether the number-of-sessions for each non-public network identifier reaches a corresponding first value, session control may be performed on a non-public network identifier-by-non-public network identifier basis, thereby reducing control granularity, and non-public networks may also be managed and controlled based on the usage of session resources, thereby meeting requirements for finer-grained network management and control.

### BRIEF DESCRIPTION OF THE DRAWINGS

FIG. 1 is a flow chart of a session control method according to an embodiment of the present disclosure;

FIG. 2 is another flow chart of a session control method according to an embodiment of the present disclosure;

FIG. 3 is a flow chart of a charging method according to an embodiment of the present disclosure;

FIG. 4 is another flow chart of a charging method according to an embodiment of the present disclosure;

FIG. 5 is a schematic diagram of a session control and charging process according to an embodiment of the present disclosure;

FIG. 6 is another schematic diagram of a session control and charging process according to an embodiment of the present disclosure;

FIG. 7 is a schematic structural diagram of a session control apparatus according to an embodiment of the present disclosure;

FIG. 8 is another schematic structural diagram of a session control apparatus according to an embodiment of the present disclosure;

FIG. 9 is a schematic structural diagram of a charging apparatus according to an embodiment of the present disclosure;

FIG. 10 is another schematic structural diagram of a charging apparatus according to an embodiment of the present disclosure;

FIG. 11 is a schematic structural diagram of a communication device according to an embodiment of the present disclosure.

### DETAILED DESCRIPTION

The following clearly and completely describes the technical solutions in the embodiments of the present disclosure with reference to the accompanying drawings in the embodiments of the present disclosure. Apparently, the described embodiments are only some embodiments of the present disclosure rather than all the embodiments. All other embodiments obtained by persons of ordinary skill in the art based on the embodiments of the present disclosure without creative efforts fall within the scope of the present disclosure.

The terms such as “first” and “second” in the specification and claims of the present disclosure are only used to distinguish between similar objects, but are not used to describe a specific order or time sequence. It should be understood that the data thus used are interchangeable in appropriate circumstances and that embodiments of the present disclosure can be implemented in other sequences than those illustrated or described. In addition, the objects distinguished by “first”, “second”, and the like are usually of one type, and a quantity of the objects is not limited. For example, one or more first objects may be provided. In addition, the term “and/or” in the description and claims represents at least one of associated objects. The symbol “/” generally indicates an “or” relationship between the objects connected.

In embodiments of the present disclosure, two types of NPNs (NPNs) are included. One type is a stand-alone NPN (SNPN). The SNPN usually uses a dedicated wireless network or a core network. The other type is a PNI-NPN. Depending on a public land mobile network of an operator, the PNI-NPN can fully utilize network resources of the operator to provide an industry customer with a quick private network service, for example, a 5^{th} generation mobile communication technology (5G). A function of closed access group (CAG) can be introduced in a PNI-NPN. CAG can be understood as closed access group, closed access group identifier, etc.

Optionally, different PNI-NPNs may be identified by closed access group identifiers (e.g., CAG IDs). Different SNPNs may be identified by public land mobile network identifiers (PLMN IDs) and/or network identifiers (NIDs).

It is understood that, managing and controlling non-public networks based on the usage of session resources (such as industry customers' usage of session resources) is conducive to a more fine-grained management and control of the network and a more precise network capacity planning. At the same time, tiered charging based on the usage of session resources (such as industry customers' usage of session resources) can assist in providing more varied charging packages/marketing tools and providing more choices for industry customers.

Optionally, scenarios to which the embodiments of the present disclosure are applicable include, but are not limited to: 5G industry private networks, and 6th generation mobile communication technology (6G) industry private networks.

It should be noted that in the embodiments of the present disclosure, the number-of-sessions may be, but not limited to: the number of protocol data unit (PDU) sessions, or the number of PDUs.

The session control method and apparatus, charging method and apparatus, communication device and readable storage medium according to the embodiments of the present disclosure are described in detail below with reference to the accompanying drawings in connection with specific embodiments and their application scenarios.

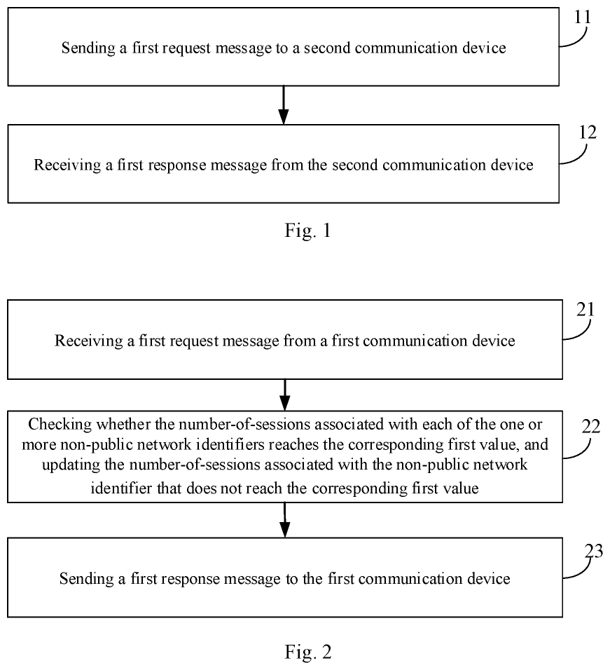

Please refer to FIG. 1, which is a flow chart of a session control method according to an embodiment of the present disclosure. The method is performed by a first communication device, and the first communication device may include, but is not limited to: a session management function (SMF), or an access and mobility management function (AMF). As shown in FIG. 1, the method includes the following steps 11 and 12.

Step 11: Sending a first request message to a second communication device.

In this embodiment, the first request message includes one or more non-public network identifiers, and is used for requesting updating a number-of-sessions for each of the one or more non-public network identifiers. The one or more non-public network identifiers can be understood as at least one non-public network identifier. The non-public network identifier is the identifier of the non-public network that allows access.

Optionally, the first request message may also include at least one of the following: a terminal identifier (e.g., UE ID), a session ID (e.g., a PDU session ID), or second indication information. The terminal identifier can be used for indicating the terminal that initiates the establishment, release or modification of the PDU session. The second indication information can be understood as an update flag, which is used for indicating that the number-of-sessions for each non-public network identifier is to be increased or decreased, so that the second communication device increases or decreases the number-of-sessions for the corresponding non-public network identifier. The increase can be understood as an increase in the number of PDU sessions established on the non-public network corresponding to the non-public network identifier (e.g., CAG identifier, or PLMN ID and/or NID); the decrease can be understood as a reduction in the number of PDU sessions established on the non-public network corresponding to the non-public network identifier (e.g., CAG identifier, or PLMN ID and/or NID).

In some embodiments, the non-public network may be a PNI-NPN or an SNPN.

In some embodiments, the non-public network has a CAG function and can be identified by a closed access group identifier (CAG ID).

In some embodiments, the non-public network may be identified by a public land mobile network identifier (PLMN ID) and/or a network identifier (NID).

In some embodiments, the second communication device may include, but is not limited to, a non-public network admission control function (NPNACF), or a network slice admission control function (NSACF). For example, taking the first communication device being an SMF as an example, the SMF can send a first request message to an NPNACF or NSACF; taking the first communication device being an AMF as an example, the AMF can send a first request message to the NPNACF or NSACF.

It should be pointed out that, the number-of-sessions for a non-public network identifier can be understood as the number of sessions of the non-public network corresponding to the non-public network identifier, or the number of PDU sessions established on the non-public network corresponding to the non-public network identifier.

Step 12: Receiving a first response message from the second communication device.

In this embodiment, the first response message includes first indication information, and the first indication information is used for indicating whether the number-of-sessions for each of the one or more non-public network identifiers reaches the corresponding first value. The first value can be pre-configured based on actual needs, and/or be obtained from an operation administration and maintenance (OAM) unit, etc. The first value can be a threshold value of the number-of-sessions for the corresponding non-public network identifier. Preferably, the first value is the maximum number-of-sessions for the corresponding non-public network identifier, that is, the first indication information is used for indicating whether the number-of-sessions for each of the one or more non-public network identifiers reaches the corresponding maximum number-of-sessions, so as to use the maximum number-of-sessions (e.g., the maximum number of established sessions) as the limit of the number of sessions for the non-public network. The maximum number-of-sessions and/or the threshold of number-of-sessions may vary or remain the same for different non-public network identifiers.

In some embodiments, the first request message is a number-of-PDUs update request message, and correspondingly, the first response message is a number-of-PDUs update response message.

In the session control method according to the embodiment of the present disclosure, the first communication device may send a first request message to the second communication device, the first request message includes one or more non-public network identifiers, and is used for requesting updating a number-of-sessions for each of the one or more non-public network identifiers, and the first communication device receives a first response message from the second communication device, the first response message includes first indication information, and the first indication information is used for indicating whether the number-of-sessions for each of the one or more non-public network identifiers reaches the corresponding first value. Thus, through the indication as to whether the number-of-sessions for each non-public network identifier reaches the corresponding first value, session control may be performed on a non-public network identifier-by-non-public network identifier (e.g., CAG identifier, or PLMN ID and/or NID) basis, thereby reducing the control granularity, and the non-public network can also be managed and controlled based on the usage of session resources, thereby meeting the requirements for finer-grained management and control of the network.

Optionally, the one or more non-public network identifiers may include at least one of the following:
one or more closed access group (CAG) identifiers (IDs);
one or more network identifiers (NIDs); or
one or more public land mobile network identifiers (PLMN IDs).

For example, if the one or more non-public network identifiers include one or more CAG identifiers, the first request message includes one or more CAG identifiers to request updating the number-of-sessions for each of the one or more CAG identifiers; or, the one or more non-public network identifiers include one or more public land mobile network identifiers (PLMN IDs) and/or network identifiers (NIDs), to request updating a number-of-sessions for each of the non-public networks corresponding to the one or more PLMN IDs and/or NIDs.

In the embodiment of the present disclosure, the first communication device may send a first request message to the second communication device based on the establishment, release or modification of the PDU session initiated by a third communication device. Optionally, before sending the first request message to the second communication device, the first communication device may first receive a second request message from the third communication device, wherein the second request message is used for requesting at least one of the following: establishment of a PDU session, release of a PDU session, and modification of a PDU session; and then, based on the received second request message, the first communication device sends a corresponding first request message to the second communication device to increase or decrease the number-of-sessions for the corresponding non-public network identifier.

Optionally, the second request message includes one or more non-public network identifiers (e.g., one or more CAG identifiers, or PLMN IDs and/or NIDs), and the one or more non-public network identifiers are the same as the one or more non-public network identifiers included in the first request message, that is, the one or more non-public network identifiers included in the first request message is obtained from the second request message.

In some embodiments, the third communication device may be an AMF or a terminal. For example, if the first communication device is an SMF, the SMF may receive from the AMF a second request message which requests establishing a PDU session, releasing a PDU session, or modifying a PDU session; thereafter, the SMF may send a first request message to the second communication device (e.g., NPNACF or NSACF) to request updating a number-of-sessions for the corresponding non-public network identifier. For another example, if the first communication device is an AMF, the AMF may receive from the terminal a second request message which requests establishing a PDU session, releasing a PDU session, or modifying a PDU session; thereafter, the AMF may send a first request message to the second communication device (e.g., NPNACF or NSACF) to request updating a number-of-sessions for the corresponding non-public network identifier.

In some embodiments, the second request message may be one of the following: a PDU session establishment request message, which is used for requesting establishing a PDU session; a PDU session release request message, which is used for requesting releasing a PDU session; a PDU session modification request message, which is used for requesting modifying a PDU session.

Optionally, when the second request message is used for requesting establishing a PDU session, after receiving the first response message from the second communication device, in a case that the first indication information indicates that the number-of-sessions for at least one of the one or more non-public network identifiers does not reach the corresponding first value, the first communication device may send a second response message to the third communication device, and the second response message is used for indicating that the request for establishing the PDU session is accepted; or, if the first indication information indicates that the number-of-sessions for each of the one or more non-public network identifiers reaches the corresponding first value, the first communication device may send a third response message to the third communication device, and the third response message is used for indicating that the request for establishing the PDU session is rejected. That is, if the number-of-sessions for none or only some of the non-public network identifiers reaches the corresponding first value (e.g., the maximum number-of-sessions), the result that the request for establishing the PDU session is accepted is responded to the third communication device, that is, the request for establishing the PDU session is accepted; and if the number-of-sessions for the non-public network identifiers all reaches the corresponding first values (e.g., the maximum number-of-sessions), the result that the request for establishing the PDU session is rejected is responded to the third communication device, that is, the request for establishing the PDU session is rejected.

Optionally, the third response message may include a cause value, and the cause value is used for indicating that a reason for rejecting the request for establishing the PDU session is that the numbers of sessions for the one or more non-public network identifiers all reach corresponding first values, so that the third communication device knows the reason for rejecting the request for establishing the PDU session.

Optionally, when the number-of-sessions for each of the one or more non-public network identifiers reaches the corresponding first value (e.g., the maximum number-of-sessions), the first communication device may reject a subsequent PDU session establishment request message for establishing a PDU session to any one of the one or more non-public networks corresponding to the one or more non-public network identifiers respectively, that is, the first communication device does not send a first request message to the second communication device, and directly rejects subsequent new PDU session establishment request messages that only contain these non-public network identifiers.

Optionally, when the number-of-sessions for each of the one or more non-public network identifiers reaches the corresponding first value (e.g., the maximum number-of-sessions), the first response message may also include notification information, and the notification information is used for notifying the first communication device that a subsequent PDU session establishment request message for establishing a PDU session to any one of the one or more non-public networks corresponding to the one or more non-public network identifiers respectively is to be rejected, that is, to notify the first communication device that the first communication device should no longer accept subsequent PDU session establishment request messages containing only these non-public network identifiers. Accordingly, the first communication device does not send the first request message to the second communication device, and directly rejects subsequent new PDU session establishment request messages containing only these non-public network identifiers.

Optionally, when the first indication information indicates that the number-of-sessions for a second non-public network identifier reaches the corresponding first value, the second non-public network identifier being any one of the one or more non-public network identifiers, the first communication device may send a subscription request to the second communication device, the subscription request being used for requesting the second communication device to notify the first communication device when the number-of-sessions for the second non-public network identifier is less than the corresponding first value; then, when the number-of-sessions for the second non-public network identifier is less than the corresponding first value, the first communication device receives a notification message from the second communication device, the notification message being used for notifying that the number-of-sessions for the second non-public network identifier is less than the corresponding first value. In this case, after receiving the PDU session establishment request message for establishing a PDU session to the non-public network corresponding to the second non-public network identifier, the first communication device does not reject the PDU session establishment request message, but initiates a subsequent process.

Optionally, in a case that the first communication device is an SMF, each non-public network identifier included in the first request message may be received by the SMF from the AMF. For example, the SMF may receive a second request message sent by the AMF, and the second request message includes each of the one or more non-public network identifiers. Each non-public network identifier may be determined by the AMF based on at least one of the following: terminal subscription data (e.g., an allowed CAG list and/or a CAG-only indication, or, PLMN ID and/or NID) obtained from a fourth communication device, a non-public network identifier (e.g., PLMN ID and/or NID) notified or indicated by the radio access network, or a non-public network identifier list (e.g., a Cell CAG list) notified or indicated by the radio access network. For example, the non-public network identifier (e.g., PLMN ID and/or NID) notified or indicated by the radio access network may be selected by the radio access network. The non-public network identifier list (e.g., Cell CAG list) notified or indicated by the radio access network may be those supported by the cell.

Optionally, in a case that the first communication device is an AMF, each non-public network identifier included in the first request message may be determined by the AMF based on at least one of the following: terminal subscription data (e.g., Allowed CAG list and/or CAG-only indication, or PLMN ID and/or NID) obtained from the fourth communication device, a non-public network identifier (e.g., PLMN ID and/or NID) notified or indicated by the radio access network, or a list of non-public network identifiers (e.g., Cell CAG list) notified or indicated by the radio access network. For example, the non-public network identifier (e.g., PLMN ID and/or NID) notified or indicated by the radio access network may be selected by the radio access network. The list of non-public network identifiers (e.g., Cell CAG list) notified or indicated by the radio access network may be those supported by the cell.

The fourth communication device may include, but is not limited to, unified data management (UDM). For example, the non-public network identifier in the first request message is determined by the AMF according to at least one of the following: terminal subscription data obtained from the UDM, a non-public network identifier notified or indicated by the radio access network, or a list of non-public network identifiers notified or indicated by the radio access network.

Please refer to FIG. 2, which is a flow chart of a session control method according to an embodiment of the present disclosure. The method is performed by a second communication device, and the second communication device may include, but is not limited to, NPNACF, or NSACF. As shown in FIG. 2, the method includes the following steps 21 to 23.

Step 21: Receiving a first request message from a first communication device.

In this embodiment, the first request message includes one or more non-public network identifiers, and is used for requesting updating a number-of-sessions for each of the one or more non-public network identifiers. The one or more non-public network identifiers can be understood as at least one non-public network identifier. The non-public network identifier is the identifier of the non-public network that allows access.

Optionally, the first request message may also include at least one of the following: a terminal identifier (e.g., UE ID), a PDU session ID, or second indication information. The terminal identifier can be used for indicating the terminal that initiates the establishment, release or modification of the PDU session. The second indication information can be understood as an update flag, which is used for indicating that the number-of-sessions for each of the one or more non-public network identifiers is to be increased or decreased, so that the second communication device increases or decreases the number-of-sessions for the corresponding non-public network identifier. The increase can be understood as an increase in the number of PDU sessions established on the non-public network corresponding to the non-public network identifier (e.g., CAG identifier, or PLMN ID and/or NID); the decrease can be understood as a reduction in the number of PDU sessions established on the non-public network corresponding to the non-public network identifier (e.g., CAG identifier, or PLMN ID and/or NID).

In some embodiments, the non-public network may be a PNI-NPN or an SNPN.

In some embodiments, the non-public network has a CAG function and can be identified by a closed access group identifier (CAG ID).

In some embodiments, the non-public network may be identified by a public land mobile network identifier (PLMN ID) and/or a network identifier (NID).

It should be pointed out that the number-of-sessions for a non-public network identifier can be understood as the number of sessions of the non-public network corresponding to the non-public network identifier, or the number of PDU sessions established on the non-public network corresponding to the non-public network identifier.

Step 22: Checking whether the number-of-sessions for each of the one or more non-public network identifiers reaches the corresponding first value, and updating the number-of-sessions for the non-public network identifier that does not reach the corresponding first value.

In this embodiment, the first value can be pre-configured based on actual needs, and/or be obtained from an OAM unit, etc. The first value can be a threshold of number-of-sessions for the corresponding non-public network identifier. Preferably, the first value is the maximum number-of-sessions for the corresponding non-public network identifier, so that the maximum number-of-sessions (e.g., the maximum number of established sessions) is used as the limit of the number of sessions for the non-public network. The maximum number-of-sessions and/or the threshold of number-of-sessions may vary or remain the same for different non-public network identifiers.

Step 23: Sending a first response message to the first communication device.

In this embodiment, the first response message includes first indication information, and the first indication information is used for indicating whether the number-of-sessions for each of the one or more non-public network identifiers reaches the corresponding first value. For example, when the first value is the maximum number-of-sessions for the corresponding non-public network identifier, the first indication information is used for indicating whether the number-of-sessions for each of the one or more non-public network identifiers reaches the corresponding maximum number-of-sessions.

In some embodiments, the first request message is a number-of-PDUs update request message, and correspondingly, the first response message is a number-of-PDUs update response message.

Therefore, through the indication as to whether the number-of-sessions for each of the one or more non-public network identifiers reaches the corresponding first value, session control may be performed on a non-public network identifier-by-non-public network identifier (e.g., CAG identifier, or PLMN ID and/or NID) basis, thereby reducing the control granularity, and the non-public network can also be managed and controlled based on the usage of session resources, thereby meeting the requirements for finer-grained management and control of the network.

Optionally, in a case that the number-of-sessions for each of the one or more non-public network identifiers reaches the corresponding first value (e.g., the maximum number-of-sessions), the first response message may also include notification information, and the notification information is used for notifying the first communication device that a subsequent PDU session establishment request message for establishing a PDU session to any one of the one or more non-public networks corresponding to the one or more non-public network identifiers respectively is to be rejected, that is, to notify the first communication device that the first communication device should no longer accept subsequent PDU session establishment request messages containing only these non-public network identifiers. Accordingly, the first communication device does not send the first request message to the second communication device, and directly rejects subsequent new PDU session establishment request messages containing only these non-public network identifiers.

Optionally, in a case that the first indication information indicates that the number-of-sessions for a second non-public network identifier reaches the corresponding first value, the second non-public network identifier being any one of the one or more non-public network identifiers, the second communication device may receive a subscription request from the first communication device, the subscription request being used for requesting the second communication device to notify the first communication device when the number-of-sessions for the second non-public network identifier is less than the corresponding first value; then, when the number-of-sessions for the second non-public network identifier is less than the corresponding first value, the second communication device sends a notification message to the first communication device, the notification message being used for notifying that the number-of-sessions for the second non-public network identifier is less than the corresponding first value. In this case, after receiving the PDU session establishment request message for establishing a PDU session to the non-public network corresponding to the second non-public network identifier, the first communication device does not reject the PDU session establishment request message, but initiates a subsequent process.

Optionally, the one or more non-public network identifiers may include at least one of the following:
one or more closed access group (CAG) identifiers (IDs);
one or more network identifiers (NIDs); or
one or more public land mobile network identifiers (PLMN IDs).

Optionally, this embodiment may perform charging based on the usage of session resources. In a case that the number-of-sessions for a first non-public network identifier reaches the corresponding first value or a second value, the second communication device may send a third request message to the fifth communication device, the third request message being used for reporting the number-of-sessions for the first non-public network identifier, and the fifth communication device performs a charging processing based on the number-of-sessions for the first non-public network identifier. The number-of-sessions for the first non-public network identifier may be the number of sessions that have been used or established in the non-public network corresponding to the first non-public network identifier. The first non-public network identifier is an identifier of any non-public network that allows a terminal to access. The first value is the maximum number-of-sessions for the first non-public network identifier, the first value is greater than the second value, and the second value is any one of thresholds of number-of-sessions for the first non-public network identifier, that is, the second value may be a different threshold of number-of-sessions. The charging processing is not limited to account, rating control, and the like. Subsequently, the second communication device may receive a fourth response message from the fifth communication device, and the fourth response message may include an indication of success or failure, etc.

That is to say, when the number-of-sessions for a non-public network identifier (e.g., the number of established sessions) reaches the corresponding threshold of number-of-sessions or the maximum number-of-sessions, the second communication device can send a third request message to the fifth communication device to report the number-of-sessions for the non-public network identifier, to enable the fifth communication device to perform a charging processing based on the number-of-sessions for the non-public network identifier, and the second communication device receives a fourth response message from the fifth communication device. That the number-of-sessions for the non-public network identifier reaches the corresponding threshold of number-of-sessions may be that the number-of-sessions for the non-public network identifier increases to the corresponding threshold of number-of-sessions, or that the number-of-sessions for the non-public network identifier decreases to the corresponding threshold of number-of-sessions. That the number-of-sessions for the non-public network identifier reaches the corresponding maximum number-of-sessions is that the number-of-sessions for the non-public network identifier increases to the corresponding maximum number-of-sessions. In this way, the number-of-sessions can be used as a basis for judging the usage of session resources, to achieve a charging based on the number of sessions accessing the network. When multiple thresholds of number-of-sessions are set, a tiered charging depending on the usage of session resources can be implemented, providing more choices for industry customers.

In some embodiments, the fifth communication device may be a charging function (CHF) and/or a charging system (e.g., a converged charging system (CCS) or the like). The CHF and the charging system may be integrated or separately provided. For example, the CHF and/or the charging system may perform a charging processing based on the received third request message.

In some embodiments, the third request message may be a charging data request, which may be sent by the second communication device by invoking a charging service (e.g., a converged charging service, such as Nchf_NPNConvergedCharging).

For example, if three thresholds of number-of-sessions are set, namely threshold 1, threshold 2 and threshold 3, and threshold 1<threshold 2<threshold 3< a maximum number-of-sessions, then: when the number-of-sessions for the corresponding non-public network identifier is increased to threshold 1 based on a PDU session establishment/modification request, the second communication device can initiate a charging request to the fifth communication device to achieve a charging processing of a corresponding tier based on the number-of-sessions; when the number-of-sessions for the corresponding non-public network identifier is increased to threshold 2 based on the PDU session establishment/modification request, the second communication device can initiate a charging request to the fifth communication device to achieve a charging processing of the corresponding tier based on the number-of-sessions; when the number-of-sessions for the corresponding non-public network identifier is increased to threshold 3 based on the PDU session establishment/modification request, the second communication device can initiate a charging request to the fifth communication device to achieve a charging processing of the corresponding tier based on the number-of-sessions; when the number-of-sessions for the corresponding non-public network identifier is increased to a maximum number-of-sessions based on a PDU session establishment/modification request, the second communication device can initiate a charging request to the fifth communication device to achieve a charging processing of the corresponding tier based on the number-of-sessions. Alternatively, when the number-of-sessions for the corresponding non-public network identifier is reduced to threshold 3 based on a PDU session release/modification request, the second communication device may initiate a charging request to the fifth communication device to achieve a charging processing of the corresponding tier based on the number-of-sessions; when the number-of-sessions for the corresponding non-public network identifier is reduced to threshold 2 based on a PDU session release/modification request, the second communication device may initiate a charging request to the fifth communication device to achieve a charging processing of the corresponding tier based on the number-of-sessions; when the number-of-sessions for the corresponding non-public network identifier is reduced to threshold 1 based on a PDU session release/modification request, the second communication device may initiate a charging request to the fifth communication device to achieve a charging processing of the corresponding tier based on the number-of-sessions.

It should be noted that the above example is described by using 3 thresholds of number-of-sessions, but the embodiment is not limited thereto. 2 thresholds of number-of-sessions, 4 thresholds of number-of-sessions, or the like may also be set. The corresponding charging methods are the same and will not be described in detail here.

Optionally, the second request message may include at least one of the following: the first non-public network identifier, or the number-of-sessions for the first non-public network identifier. For example, the first non-public network identifier may be a CAG identifier, or the first non-public network identifier may be a PLMN ID and/or NID.

In some embodiments, the charging processing may include, but is not limited to, account, rating control and the like.

In some embodiments, the third request message may be a converged charging request message, and correspondingly, the fourth response message is a converged charging response message. Alternatively, the third request message may be a charging data request message, and correspondingly, the fourth response message is a charging data response message. Alternatively, the third request message may be a charging request message, and correspondingly, the fourth response message is a charging response message.

For example, when the number-of-sessions for any non-public network identifier (e.g., the number of established sessions) reaches the corresponding threshold of number-of-sessions or maximum number-of-sessions (for example, increases to the corresponding threshold of number-of-sessions or maximum number-of-sessions, or decreases to the corresponding threshold of number-of-sessions), an NPNACF (or NSACF) can send a charging data request message to a CHF and/or charging system to report the number-of-sessions for the non-public network identifier (i.e., the number of sessions used or established in the corresponding non-public network), and the CHF and/or the charging system performs a charging processing based on the number-of-sessions for the non-public network identifier.

In embodiments of the present disclosure, the second communication device may configure the maximum number-of-sessions for each non-public network identifier, and/or at least one threshold of number-of-sessions under the maximum number-of-sessions. And/or, the second communication device may obtain, based on each non-public network identifier, the maximum number-of-sessions for each non-public network identifier and/or at least one threshold of number-of-sessions under the maximum number-of-sessions from the sixth communication device. The maximum number-of-sessions and/or thresholds of number-of-sessions for different non-public network identifiers may be different or the same. In this way, the maximum number-of-sessions and at least one threshold of number-of-sessions for each non-public network identifier may be obtained, thereby performing session control and/or charging processing based on the number of sessions accessing the network.

In some embodiments, the sixth communication device may include but is not limited to an operation administration and maintenance (OAM) unit. For example, the NPNACF or NSACF may statically configure the maximum number-of-sessions for the non-public network identifier and/or a set of thresholds of number-of-sessions under the maximum number-of-sessions, or may obtain, according to the non-public network identifier, the maximum number-of-sessions for the non-public network identifier and/or a set of thresholds of number-of-sessions under the maximum number-of-sessions from the OAM unit.

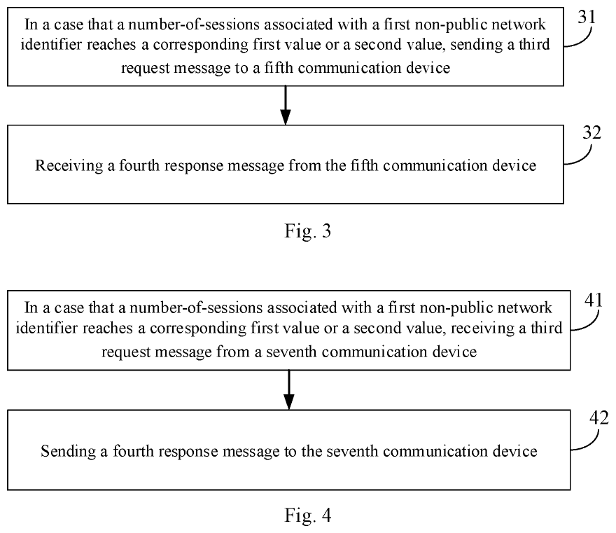

Please refer to FIG. 3, which is a flow chart of a charging method according to an embodiment of the present disclosure. The method is performed by a seventh communication device, and the seventh communication device may include but is not limited to AMF, SMF, NPNACF, NSACF, etc. As shown in FIG. 3, the method includes the following steps 31 and 32.

Step 31: In a case that a number-of-sessions for a first non-public network identifier reaches a corresponding first value or a second value, sending a third request message to a fifth communication device.

In this embodiment, the third request message is used for reporting the number-of-sessions for the first non-public network identifier, to enable the fifth communication device to perform a charging processing based on the number-of-sessions for the first non-public network identifier. The number-of-sessions for the first non-public network identifier may be the number of sessions that have been used or established in the non-public network corresponding to the first non-public network identifier. The first non-public network identifier is an identifier of any non-public network that allows a terminal to access. The first value is the maximum number-of-sessions for the first non-public network identifier, the first value is greater than the second value, and the second value is any one of the thresholds of number-of-sessions for the first non-public network identifier, that is, the second value may be a different threshold of number-of-sessions.

In some embodiments, the charging processing may include, but is not limited to, account, rating control and the like.

In some embodiments, the third request message may be a charging data request, which may be sent by the seventh communication device by invoking a charging service (e.g., a converged charging service, such as Nchf_NPNConvergedCharging).

Step 32: Receiving a fourth response message from the fifth communication device.

In this embodiment, the fourth response message may include an indication of success or failure. That is, when the number-of-sessions for a non-public network identifier (e.g., the number of established sessions) reaches the corresponding threshold of number-of-sessions or the maximum number-of-sessions, the seventh communication device may send a third request message to the fifth communication device to report the number-of-sessions for the non-public network identifier, to enable the fifth communication device to perform a charging processing based on the number-of-sessions for the non-public network identifier, and the seventh communication device receives a fourth response message from the fifth communication device. That the number-of-sessions for the non-public network identifier reaches the corresponding threshold of number-of-sessions may be that the number-of-sessions for the non-public network identifier increases to the corresponding threshold of number-of-sessions, or that the number-of-sessions for the non-public network identifier decreases to the corresponding threshold of number-of-sessions. That the number-of-sessions for the non-public network identifier reaches the corresponding maximum number-of-sessions is that the number-of-sessions for the non-public network identifier increases to the corresponding maximum number-of-sessions.

In this way, the number-of-sessions can be used as a basis for judging the usage of session resources, to achieve a charging based on the number of sessions of a non-public network, and when multiple thresholds of number-of-sessions are set, tiered charging can be realized based on the usage of session resources, providing more choices for industry customers. Furthermore, a charging based on the maximum number-of-sessions of a non-public network can be realized.

In some embodiments, the fifth communication device may be a CHF and/or a charging system (e.g., CCS, etc.). The CHF and the charging system may be integrated or separately provided. For example, the CHF and/or the charging system may perform a charging processing based on the received third request message.

For example, if three thresholds of number-of-sessions are set, namely threshold 1, threshold 2 and threshold 3, and threshold 1<threshold 2<threshold 3 < maximum number-of-sessions, then: when the number-of-sessions for the corresponding non-public network identifier is increased to threshold 1 based on the PDU session establishment/modification request, the seventh communication device can initiate a charging request to the fifth communication device to achieve a charging processing of the corresponding tier based on the number-of-sessions; when the number-of-sessions for the corresponding non-public network identifier is increased to threshold 2 based on the PDU session establishment/modification request, the seventh communication device can initiate a charging request to the fifth communication device to achieve a charging processing of the corresponding tier based on the number-of-sessions; when the number-of-sessions for the corresponding non-public network identifier is increased to threshold 3 based on a PDU session establishment/modification request, the seventh communication device can initiate a charging request to the fifth communication device to achieve a charging processing of the corresponding tier based on the number-of-sessions; when the number-of-sessions for the corresponding non-public network identifier is increased to a maximum number-of-sessions based on a PDU session establishment/modification request, the seventh communication device can initiate a charging request to the fifth communication device to achieve a charging processing of the corresponding tier based on the number-of-sessions. Alternatively, when the number-of-sessions for the corresponding non-public network identifier is reduced to threshold 3 based on a PDU session release/modification request, the seventh communication device may initiate a charging request to the fifth communication device to achieve a charging processing of the corresponding tier based on the number-of-sessions; when the number-of-sessions for the corresponding non-public network identifier is reduced to threshold 2 based on a PDU session release/modification request, the seventh communication device may initiate a charging request to the fifth communication device to achieve a charging processing of the corresponding tier based on the number-of-sessions; when the number-of-sessions for the corresponding non-public network identifier is reduced to threshold 1 based on a PDU session release/modification request, the seventh communication device may initiate a charging request to the fifth communication device to achieve a charging processing of the corresponding tier based on the number-of-sessions.

It should be noted that the above example is described using 3 thresholds of number-of-sessions as an example, but the present embodiment is not limited thereto, and 2 thresholds of number-of-sessions, or 4 thresholds of number-of-sessions, etc. may also be set. The corresponding charging methods are the same and will not be described in detail here.

Optionally, the third request message may include at least one of the following: the first non-public network identifier, or the number-of-sessions for the first non-public network identifier. For example, the first non-public network identifier may be a CAG identifier, or the first non-public network identifier may be a PLMN ID and/or NID.

In some embodiments, the third request message may be a converged charging request message, and correspondingly, the fourth response message is a converged charging response message. Alternatively, the third request message may be a charging data request message, and correspondingly, the fourth response message is a charging data response message. Alternatively, the third request message may be a charging request message, and correspondingly, the fourth response message is a charging response message.

In some embodiments, taking the seventh communication device being an AMF as an example, the AMF may send a third request message to the CHF or the charging system, and receive a fourth response message from the CHF or the charging system; or, taking the seventh communication device being an SMF as an example, the SMF may send a third request message to the CHF or the charging system, and receive a fourth response message from the CHF; or, taking the seventh communication device being a NPNACF as an example, the NPNACF may send a third request message to the CHF or the charging system, and receive a fourth response message from the CHF or the charging system; or, taking the seventh communication device being a NSACF as an example, the NSACF may send a third request message to the CHF or the charging system, and receive a fourth response message from the CHF or the charging system.

In embodiments of the present disclosure, the seventh communication device may configure the maximum number-of-sessions for each of the one or more non-public network identifiers, and/or at least one threshold of number-of-sessions under the maximum number-of-sessions; and/or, the seventh communication device may obtain, based on each of the one or more non-public network identifiers, the maximum number-of-sessions for each of the one or more non-public network identifiers and/or at least one threshold of number-of-sessions under the maximum number-of-sessions from the sixth communication device. The maximum number-of-sessions and/or thresholds of number-of-sessions for different non-public network identifiers may be different or the same. In this way, the maximum number-of-sessions and at least one threshold of number-of-sessions for each non-public network identifier may be obtained, thereby performing session control and/or charging processing based on the number of established sessions.

In some embodiments, the sixth communication device may include but is not limited to an operation, maintenance and management (OAM) unit. For example, the NPNACF may statically configure the maximum number-of-sessions for the non-public network identifier and/or a set of thresholds of number-of-sessions under the maximum number-of-sessions, or may obtain, based on the non-public network identifier, the maximum number-of-sessions for the non-public network identifier and/or a set of thresholds of number-of-sessions under the maximum number-of-sessions from the OAM unit.

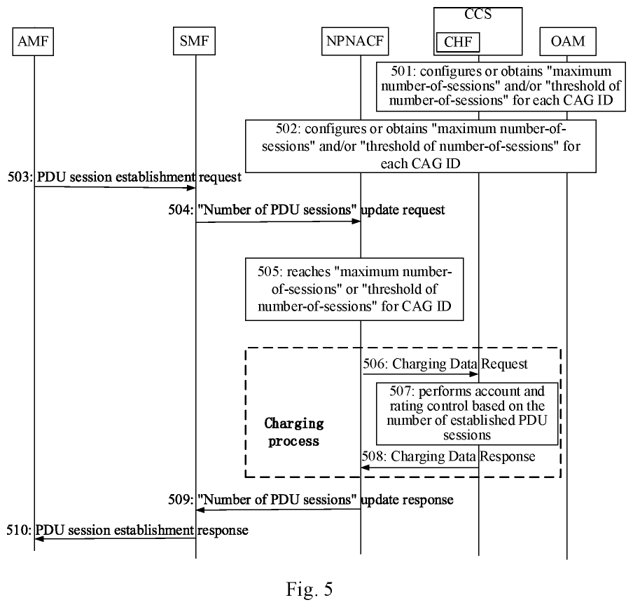

Please refer to FIG. 4, which is a flow chart of a charging method according to an embodiment of the present disclosure. The method is performed by a fifth communication device, and the fifth communication device includes but is not limited to CHF, a charging system. The charging system is, for example, CCS and the like. As shown in FIG. 4, the method includes the following steps 41 and 42.

Step 41: In a case that a number-of-sessions for a first non-public network identifier reaches a corresponding first value or a second value, receiving a third request message from a seventh communication device.

In this embodiment, the third request message is used for reporting the number-of-sessions for the first non-public network identifier, and the fifth communication device performs a charging processing based on the number-of-sessions for the first non-public network identifier. The number-of-sessions for the first non-public network identifier may be the number of sessions that have been used or established in the non-public network corresponding to the first non-public network identifier. The first non-public network identifier is an identifier of any non-public network that allows a terminal to access. The first value is the maximum number-of-sessions for the first non-public network identifier, the first value is greater than the second value, and the second value is any one of the threshold of number-of-sessions for the first non-public network identifier, that is, the second value may be a different threshold of number-of-sessions.

In some embodiments, the charging processing may include, but is not limited to, account, rating control and the like.

In some embodiments, the CHF and the charging system may be integrated or separately provided. The CHF and/or the charging system may perform a charging processing based on the received third request message.

Step 42: Sending a fourth response message to the seventh communication device.

In this embodiment, the fourth response message may include an indication of success or failure. That is, when the number-of-sessions for a non-public network identifier (e.g., the number of established sessions) reaches the corresponding threshold of number-of-sessions or the maximum number-of-sessions, the fifth communication device may receive the third request message from the seventh communication device to perform a charging processing based on the number-of-sessions for the non-public network identifier, and send the fourth response message to the seventh communication device.

In this way, the number-of-sessions can be used as a basis for judging the usage of session resources, to achieve a charging based on the number of sessions of a non-public network, and when multiple thresholds of number-of-sessions are set, tiered charging can be realized based on the usage of session resources, providing more choices for industry customers.

Optionally, the third request message may include at least one of the following: the first non-public network identifier, or the number-of-sessions for the first non-public network identifier. For example, the first non-public network identifier may be a CAG identifier, or the first non-public network identifier may be a PLMN ID and/or NID.

In some embodiments, the third request message may be a charging data request message, and correspondingly, the fourth response message is a charging data response message. For example, when the number-of-sessions for any non-public network identifier (e.g., the number of established sessions) reaches a corresponding threshold of number-of-sessions or a maximum number-of-sessions (e.g., increases to a corresponding threshold of number-of-sessions or a maximum number-of-sessions, or decreases to a corresponding threshold of number-of-sessions), one of the NPNACF, NSACF, AMF, and SMF may send a charging data request message to the CHF or the charging system to report the number-of-sessions for the non-public network identifier, and the CHF or the charging system performs a charging processing based on the number-of-sessions for the non-public network identifier, and receives a charging data response message from the CHF or the charging system.

In an embodiment of the present disclosure, the fifth communication device may configure the maximum number-of-sessions for each of the one or more non-public network identifiers, and/or at least one threshold of number-of-sessions under the maximum number-of-sessions; and/or, the fifth communication device may obtain, based on each of the one or more non-public network identifiers, the maximum number-of-sessions for each of the one or more non-public network identifiers and/or at least one threshold of number-of-sessions under the maximum number-of-sessions from the sixth communication device. The maximum number-of-sessions and/or thresholds of number-of-sessions for different non-public network identifiers may be different or the same. In this way, the maximum number-of-sessions and at least one threshold of number-of-sessions for each non-public network may be obtained, thereby performing session control and/or charging processing based on the number of established sessions.

In some embodiments, the sixth communication device may include but is not limited to an OAM unit and the like. For example, the CHF may statically configure the maximum number-of-sessions for the non-public network identifier and/or a set of thresholds of number-of-sessions under the maximum number-of-sessions, or may obtain, according to the non-public network identifier, the maximum number-of-sessions for the non-public network identifier and/or a set of thresholds of number-of-sessions under the maximum number-of-sessions from the OAM unit.

A session control and charging process in an embodiment of the present disclosure is described below with reference to FIG. 5.

In the embodiment of the present disclosure, taking a PNI-NPN as an example, the session control and charging process may include the following steps S501 to S510.

S501: A CHF statically configures or obtains from an OAM unit the maximum number-of-sessions and/or a set of thresholds of number-of-sessions under the maximum number-of-sessions for each CAG identifier, the maximum number-of-sessions corresponding to the maximum value of the number-of-sessions. The number-of-sessions can be the number of PDU sessions, the number of PDUs, etc.

S502: A NPNACF statically configures or obtains from the OAM unit the maximum number-of-sessions and/or a set of thresholds of number-of-sessions under the maximum number-of-sessions for each CAG identifier, wherein different thresholds of number-of-sessions correspond to different number-of-sessions-based charging tiers, respectively.

S503: An AMF sends a PDU session establishment request (e.g., Nsmf_PDUSession_CreateSMContext Request) to an SMF.

S504: The SMF sends a first request message to the NPNACF. The first request message, for example, is a number-of-PDUs update request message (e.g., Nnpnacf_NPNAC_NumOfPDUsUpdate_Request, or Nnsacf_NSAC_NumOfPDUsUpdate_Request, or NumOfPDUsUpdate_Request), and may include at least one CAG identifier, second indication information (e.g., an update flag), etc. The second indication information is used for indicating that the number-of-sessions for each CAG identifier is to be increased or decreased.

S505: The NPNACF performs availability check and update of the number-of-sessions for each CAG identifier: checking whether the number-of-sessions for each CAG identifier reaches the corresponding maximum number-of-sessions or threshold of number-of-sessions, updating the number-of-sessions for the CAG identifier that does not reach the corresponding maximum number-of-sessions, and responding to the SMF.

If the number-of-sessions for any CAG identifier increases to the corresponding threshold of number-of-sessions or the maximum number-of-sessions, or decreases to the corresponding threshold of number-of-sessions, S506 to S508 are performed to trigger a charging process, to implement charging based on the number-of-sessions for each CAG identifier.

S506: Optionally, the NPNACF sends a third request message to the CHF or CCS. The third request message is, for example, a charging data request message, which may include a specific CAG identifier, the number of used sessions, etc. As shown in FIG. 5, the CHF and the CCS may be integrated together.

For example, the NPNACF may invoke the converged charging service to send a third request message to report the number of used sessions.

S507: The CHF or CCS performs account and rating control based on the number-of-sessions for the specific CAG identifier, that is, performs account and rating control based on the number of established sessions.

S508: The CHF or CCS returns a fourth response message to the NPNACF. The fourth response message is, for example, a charging data response message.

S509: The NPNACF returns a first response message to the SMF. The first response message is, for example, a number-of-PDUs update response message (e.g., Nnpnacf_NPNAC_NumOfPDUsUpdate_Response, or Nnsacf_NSAC_NumOfPDUsUpdate_Response, or NumOfPDUsUpdate_Response), and may include first indication information, wherein the first indication information is used for indicating whether the number-of-sessions for each CAG identifier reaches the corresponding maximum number-of-sessions.

Optionally, when all the number-of-sessions for CAG identifiers reach corresponding maximum number-of-sessions, the NPNACF can notify the SMF that the NPNACF will no longer accept subsequent PDU session establishment requests containing only these CAG identifiers, and the SMF will reject subsequent new PDU session establishment requests containing only these CAG identifiers.

S510: The SMF sends a PDU session establishment response (e.g., Nsmf_PDUSession_CreateSMContext Response) to the AMF. If it is determined according to the first indication information that none of the number-of-sessions for CAG identifiers or only some of the number-of-sessions for CAG identifiers reach the corresponding maximum number-of-sessions, the SMF accepts the PDU session establishment request. If it is determined according to the first indication information that all the number-of-sessions for CAG identifiers reach the corresponding maximum number-of-sessions, the SMF rejects the PDU session establishment request; at this time, the response message may carry a cause value which indicates that the reason for rejecting the PDU session is “all the number-of-sessions for CAG identifiers reach the maximum number of PDU sessions”.

It should be noted that the embodiment shown in FIG. 5 is described by taking the SMF sending a first request message to the NPNACF as an example. However, in addition to this, in other embodiments, the AMF may also send a first request message to the NPNACF. At this time, the AMF receives a PDU session establishment request (e.g., PDU Session establishment Request) from a terminal, and returns a PDU session establishment response to the terminal. The rest of process is similar to the above embodiment and is not repeated here. In addition, the NPNACF in the above embodiment can also be replaced by a NSACF, and the rest of process is similar. For example, the NPNACF in the embodiment shown in FIG. 5 can be replaced by a NSACF, and the description of the rest of process remains unchanged.

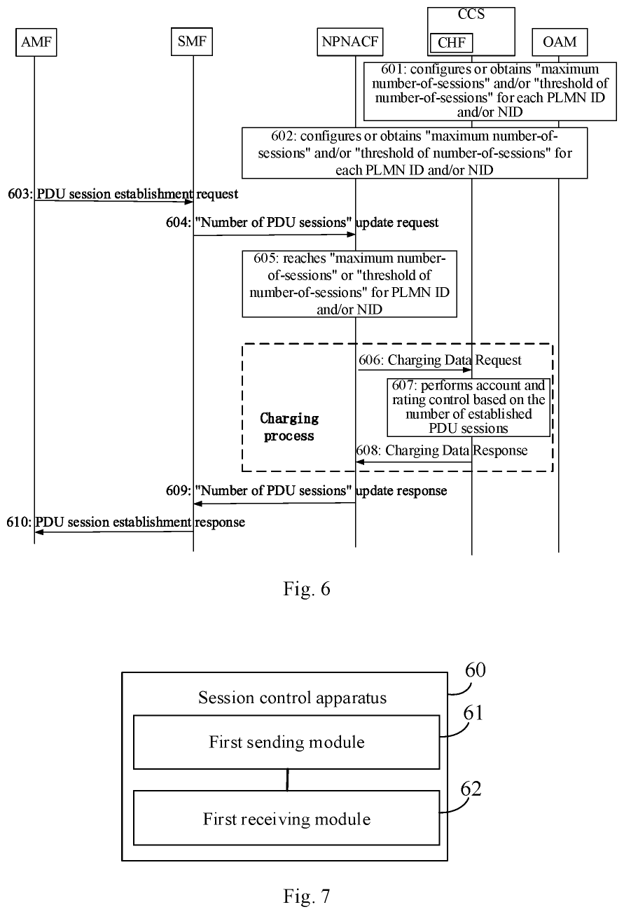

A session control and charging process in an embodiment of the present disclosure is described below with reference to FIG. 6.

In the embodiment of the present disclosure, taking the non-public network being an SNPN as an example, the session control and charging process may include the following steps S601 to S610.

S601: A CHF statically configures or obtains from an OAM unit the maximum number-of-sessions and/or a set of thresholds of number-of-sessions under the maximum number-of-sessions for each PLMN ID and/or NID, wherein the maximum number-of-sessions corresponds to the maximum value of the number-of-sessions. The number-of-sessions can be the number of PDU sessions, the number of PDUs, etc.

S602: A NPNACF statically configures or obtains from the OAM unit the maximum number-of-sessions and/or a set of thresholds of number-of-sessions under the maximum number-of-sessions for each PLMN ID and/or NID, and the different thresholds of number-of-sessions correspond to different number-of-sessions-based charging tiers, respectively.

S603: An AMF sends a PDU session establishment request (e.g., Nsmf_PDUSession_CreateSMContext Request) to an SMF.

S604: The SMF sends a first request message to the NPNACF. The first request message is, for example, a number-of-PDUs update request message (e.g., Nnpnacf_NPNAC_NumOfPDUsUpdate_Request, or Nnsacf_NSAC_NumOfPDUsUpdate_Request, or NumOfPDUsUpdate_Request), which may include at least one PLMN ID and/or NID, second indication information (e.g., an update flag), etc. The second indication information is used for indicating that the number-of-sessions for each PLMN ID and/or NID is to be increased or decreased.

S605: The NPNACF performs availability check and update of the number-of-sessions for each PLMN ID and/or NID: checking whether the number-of-sessions for each PLMN ID and/or NID reaches the corresponding maximum number-of-sessions or threshold of number-of-sessions, and updating the number-of-sessions for the PLMN ID and/or NID that does not reach the corresponding maximum number-of-sessions, and responding to the SMF.

If the number-of-sessions for any PLMN ID and/or NID increases to the corresponding threshold of number-of-sessions or the maximum number-of-sessions, or decreases to the corresponding threshold of number-of-sessions, S606 to S608 are performed to trigger a charging process, to implement charging based on the number-of-sessions for each PLMN ID and/or NID.

S606: Optionally, the NPNACF sends a third request message to the CHF or CCS, the third request message being, for example, a charging data request message, which may include a specific PLMN ID and/or NID, the number of used sessions, etc. As shown in FIG. 6, the CHF and the CCS may be integrated together.

For example, the NPNACF may invoke a converged charging service to send a third request message to report the number of used sessions.

S607: The CHF or CCS performs account and rating control based on the number-of-sessions for the specific PLMN ID and/or NID, that is, performs account and rating control based on the number of established sessions.

S608: The CHF or CCS returns a fourth response message to the NPNACF. The fourth response message is, for example, a charging data response message.

S609: The NPNACF returns a first response message to the SMF. The first response message is, for example, a number-of-PDUs update response message (e.g., Nnpnacf_NPNAC_NumOfPDUsUpdate_Response, or

Nnsacf_NSAC_NumOfPDUsUpdate_Response, or NumOfPDUsUpdate_Response), and may include first indication information, wherein the first indication information is used for indicating whether the number-of-sessions for each PLMN ID and/or NID reaches the corresponding maximum number-of-sessions.

Optionally, when all the number-of-sessions for PLMN IDs and/or NIDs reach the corresponding maximum number-of-sessions, the NPNACF may notify the SMF that subsequent PDU session establishment requests containing only these PLMN IDs and/or NIDs will no longer be accepted, and the SMF will reject subsequent new PDU session establishment requests containing only these PLMN IDs and/or NIDs.

S610: The SMF sends a PDU session establishment response (e.g., Nsmf_PDUSession_CreateSMContext Response) to the AMF. If it is determined according to the first indication information that none of the number-of-sessions for PLMN IDs and/or NIDs or only some of the number-of-sessions for PLMN IDs and/or NIDs reach the corresponding maximum number-of-sessions, the SMF accepts the PDU session establishment request. If it is determined according to the first indication information that all the number-of-sessions for PLMN IDs and/or NIDs reach the corresponding maximum number-of-sessions, the SMF rejects the PDU session establishment request; at this time, the response message may carry a cause value which indicates that the reason for rejecting the PDU session is “all the number-of-sessions for PLMN IDs and/or NIDs reach the maximum number of PDU sessions”.

It should be noted that the embodiment shown in FIG. 6 is described by taking the SMF sending a first request message to the NPNACF as an example. However, in addition to this, in other embodiments, the AMF may also send a first request message to the NPNACF. At this time, the AMF receives a PDU session establishment request (e.g., PDU Session establishment Request) from a terminal, and returns a PDU session establishment response to the terminal. The rest of process is similar to the above embodiment and is not repeated here. In addition, the NPNACF in the above embodiment can also be replaced by a NSACF, and the rest of process is similar. For example, the NPNACF in the embodiment shown in FIG. 6 can be replaced by NSACF, and the description of the rest of process remains unchanged.

The session control method provided in the embodiment of the present disclosure may be performed by a session control apparatus. A session control apparatus according to an embodiment of the present disclosure is described by taking the session control apparatus performing the session control method as an example.

Please refer to FIG. 7, which is a schematic structural diagram of a session control apparatus according to an embodiment of the present disclosure, and the apparatus is applied to a first communication device, and the first communication device includes but is not limited to SMF, AMF, etc. As shown in FIG. 7, the session control apparatus 60 includes:
a first sending module 61, configured to send a first request message to a second communication device, wherein the first request message includes one or more non-public network identifiers and is used for requesting updating a number-of-sessions for each of the one or more non-public network identifiers;
a first receiving module 62, configured to receive a first response message from the second communication device, wherein the first response message includes first indication information, and the first indication information is used for indicating whether the number-of-sessions for each of the one or more non-public network identifiers reaches a corresponding first value.

Optionally, the first value is the maximum number-of-sessions for the corresponding non-public network identifier.

Optionally, the session control apparatus 60 further includes:
a second receiving module, configured to receive a second request message from a third communication device, wherein the second request message is used for requesting at least one of the following: establishing a PDU session, releasing a PDU session, or modifying a PDU session.

Optionally, the session control apparatus 60 further includes:
a second sending module, configured to send a second response message to the third communication device in a case that the first indication information indicates that the number-of-sessions for at least one of the one or more non-public network identifiers does not reach the corresponding first value, wherein the second response message is used for indicating that the request for establishing the PDU session is accepted; or, send a third response message to the third communication device in a case that the first indication information indicates that the number-of-sessions for each of the one or more non-public network identifiers reaches the corresponding first value, wherein the third response message is used for indicating that the request for establishing the PDU session is rejected.

Optionally, the third response message includes a cause value, wherein the cause value is used for indicating that a reason for rejecting the request for establishing the PDU session is that the numbers of sessions for the one or more non-public network identifiers all reach corresponding first values.

Optionally, the session control apparatus 60 includes:
a rejection module, configured to reject the subsequent PDU session establishment request message for establishing a PDU session to any one of the one or more non-public networks corresponding to the one or more non-public network identifiers respectively in a case that the number-of-sessions for each of the one or more non-public network identifiers reaches the corresponding first value.

Optionally, in a case that the number-of-sessions for each of the one or more non-public network identifiers reaches the corresponding first value, the first response message further includes notification information, wherein the notification information is used for notifying the first communication device that a subsequent PDU session establishment request message for establishing a PDU session to any one of the one or more non-public networks corresponding to the one or more non-public network identifiers respectively is to be rejected.

Optionally, in a case that the first indication information indicates that the number-of-sessions for a second non-public network identifier reaches the corresponding first value, the second non-public network identifier being any one of the one or more non-public network identifiers, the first sending module 61 is further configured to: send a subscription request to the second communication device, wherein the subscription request is used for requesting the second communication device to notify the first communication device when the number-of-sessions for the second non-public network identifier is less than the corresponding first value;
the first receiving module 62 is further configured to: in a case that the number-of-sessions for the second non-public network identifier is less than the corresponding first value, receive a notification message from the second communication device, wherein the notification message is used for notifying that the number-of-sessions for the second non-public network identifier is less than the corresponding first value.

Optionally, in a case that the first communication device is an SMF, each of the one or more non-public network identifiers is received by the SMF from the AMF, and each of the one or more non-public network identifiers is determined by the AMF based on at least one of the following: terminal subscription data obtained from a fourth communication device, a non-public network identifier notified or indicated by a radio access network, or a list of non-public network identifiers notified or indicated by the radio access network;
or, in a case that the first communication device is an AMF, each of the one or more non-public network identifiers is determined by the AMF based on at least one of the following: terminal subscription data obtained from a fourth communication device, a non-public network identifier notified or indicated by a radio access network, or a list of non-public network identifiers notified or indicated by the radio access network.

Optionally, the first request message further includes at least one of the following:
a terminal identifier, or second indication information; wherein the second indication information is used for indicating that the number-of-sessions for each of the one or more non-public network identifiers is to be increased or decreased.

Optionally, the one or more non-public network identifiers include at least one of the following:
one or more closed access group (CAG) identifiers (IDs);
one or more network identifiers (NIDs); or
one or more public land mobile network identifiers (PLMN IDs).

It is understandable that the session control apparatus 60 according to the embodiment of the present disclosure can implement each process of the method embodiment shown in FIG. 1, and can achieve the same technical effect. To avoid repetition, it will not be described here.

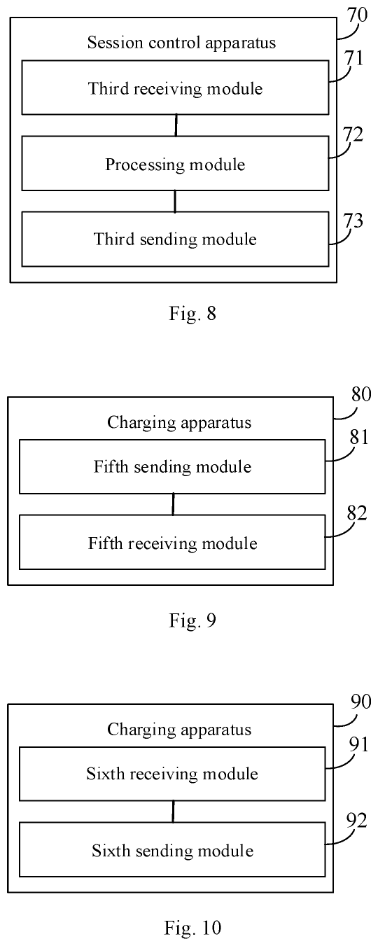

Please refer to FIG. 8, which is a schematic structural diagram of a session control apparatus according to an embodiment of the present disclosure. The session control apparatus is applied to a second communication device, and the second communication device includes but is not limited to NPNACF, NSACF, etc. As shown in FIG. 8, the session control apparatus 70 includes:
a third receiving module 71, configured to receive a first request message from a first communication device, wherein the first request message includes one or more non-public network identifiers and is used for requesting updating a number-of-sessions for each of the one or more non-public network identifiers;
a processing module 72, configured to check whether the number-of-sessions for each of the one or more non-public network identifiers reaches a corresponding first value, and to update the number-of-sessions for the non-public network identifier that does not reach the corresponding first value;
a third sending module 73, configured to send a first response message to the first communication device, wherein the first response message includes first indication information, and the first indication information is used for indicating whether the number-of-sessions for each of the one or more non-public network identifiers reaches the corresponding first value.

Optionally, the first value is the maximum number-of-sessions for the corresponding non-public network identifier.

Optionally, in a case that the number-of-sessions for each of the one or more non-public network identifiers reaches the corresponding first value, the first response message further includes notification information, and the notification information is used for notifying the first communication device that a subsequent PDU session establishment request message for establishing a PDU session to any one of the one or more non-public networks corresponding to the one or more non-public network identifiers respectively is to be rejected.

Optionally, the session control apparatus 70 further includes:
a fourth sending module, configured to send a third request message to a fifth communication device in a case that a number-of-sessions for a first non-public network identifier reaches the corresponding first value or a second value, the third request message being used for reporting the number-of-sessions for the first non-public network identifier to enable the fifth communication device to perform a charging processing based on the number-of-sessions for the first non-public network identifier, wherein the first non-public network identifier is any one of the one or more non-public network identifiers, the first value is a maximum number-of-sessions for the first non-public network identifier, the first value is greater than the second value, and the second value is any one of thresholds of number-of-sessions for the first non-public network identifier;
a fourth receiving module, configured to receive a fourth response message from the fifth communication device.

Optionally, in a case that the first indication information indicates that the number-of-sessions for a second non-public network identifier reaches the corresponding first value, the second non-public network identifier being any one of the one or more non-public network identifiers, the third receiving module 71 is further configured to: receive a subscription request from the first communication device, the subscription request being used for requesting the second communication device to notify the first communication device when the number-of-sessions for the second non-public network identifier is less than the corresponding first value;
wherein the third sending module 73 is further configured to: when the number-of-sessions for the second non-public network identifier is less than the corresponding first value, send a notification message to the first communication device, wherein the notification message is used for notifying that the number-of-sessions for the second non-public network identifier is less than the corresponding first value.

Optionally, the second request message includes at least one of the following:
the first non-public network identifier, or the number-of-sessions for the first non-public network identifier.

Optionally, the session control apparatus 70 further includes:
a first execution module, configured to execute at least one of the following:
configuring a maximum number-of-sessions for each of the one or more non-public network identifiers, and/or at least one threshold of number-of-sessions under the maximum number-of-sessions; or
obtaining, according to each of the one or more non-public network identifiers, the maximum number-of-sessions for each of the one or more non-public network identifiers and/or the at least one threshold of number-of-sessions under the maximum number-of-sessions from a sixth communication device.

Optionally, the one or more non-public network identifiers include at least one of the following:
one or more closed access group (CAG) identifiers (IDs);
one or more network identifiers (NIDs); or
one or more public land mobile network identifiers (PLMN IDs).

It is understandable that the session control apparatus 70 according to the embodiment of the present disclosure can implement each process of the method embodiment shown in FIG. 2, and can achieve the same technical effect. To avoid repetition, it will not be described here.

The charging method provided in the embodiment of the present disclosure may be performed by a charging apparatus. A charging apparatus according to the embodiment of the present disclosure is described by taking a charging apparatus performing the charging method as an example.

Please refer to FIG. 9, which is a schematic structural diagram of a charging apparatus according to an embodiment of the present disclosure. The charging apparatus is applied to a seventh communication device, and the seventh communication device includes but is not limited to AMF, SMF, NPNACF, NSACF, etc. As shown in FIG. 9, the charging apparatus 80 includes:

a fifth sending module 81, configured to send a third request message to a fifth communication device in a case that a number-of-sessions for a first non-public network identifier reaches a corresponding first value or a second value, the third request message being used for reporting the number-of-sessions for the first non-public network identifier to enable the fifth communication device to perform a charging processing based on the number-of-sessions for the first non-public network identifier, wherein the first value is a maximum number-of-sessions for the first non-public network identifier, the first value is greater than the second value, and the second value is any one of thresholds of number-of-sessions for the first non-public network identifier;
a fifth receiving module 82, configured to receive a fourth response message from the fifth communication device.

Optionally, the second request message includes at least one of the following:

the first non-public network identifier, or the number-of-sessions for the first non-public network identifier.

Optionally, the charging apparatus 80 includes:
a second execution module, configured to execute at least one of the following:
configuring a maximum number-of-sessions for each of the one or more non-public network identifiers, and/or at least one threshold of number-of-sessions under the maximum number-of-sessions; or
obtaining, according to each of the one or more non-public network identifiers, the maximum number-of-sessions for each of the one or more non-public network identifiers and/or the at least one threshold of number-of-sessions under the maximum number-of-sessions from a sixth communication device.

It is understandable that the charging apparatus 80 according to the embodiment of the present disclosure can implement each process of the method embodiment shown in FIG. 3, and can achieve the same technical effect. To avoid repetition, it will not be described here.

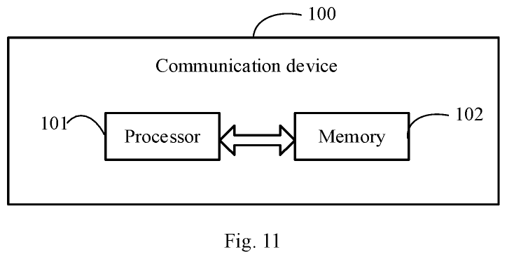

Please refer to FIG. 10, which is a schematic structural diagram of a charging apparatus according to an embodiment of the present disclosure. The charging apparatus is applied to a fifth communication device, and the fifth communication device includes but is not limited to CHF, CCS, etc. As shown in FIG. 10, the charging apparatus 90 includes:
a sixth receiving module 91, configured to receive a third request message from a seventh communication device in a case that a number-of-sessions for a first non-public network identifier reaches a corresponding first value or a second value, the third request message being used for reporting the number-of-sessions for the first non-public network identifier, wherein the fifth communication device performs a charging processing based on the number-of-sessions for the first non-public network identifier, the first value is a maximum number-of-sessions for the first non-public network identifier, the first value is greater than the second value, and the second value is any one of thresholds of number-of-sessions for the first non-public network identifier;
a sixth sending module 92, configured to send a fourth response message to the seventh communication device.

Optionally, the second request message includes at least one of the following:
the first non-public network identifier, or the number-of-sessions for the first non-public network identifier.

Optionally, the charging apparatus 90 includes:
a third execution module, configured to execute at least one of the following:
configuring a maximum number-of-sessions for each of the one or more non-public network identifiers, and/or at least one threshold of number-of-sessions under the maximum number-of-sessions; or,
obtaining, according to each of the one or more non-public network identifiers, the maximum number-of-sessions for each of the one or more non-public network identifiers and/or the at least one threshold of number-of-sessions under the maximum number-of-sessions from the sixth communication device.

It is understandable that the charging apparatus 90 according to the embodiment of the present disclosure can implement each process of the method embodiment shown in FIG. 4, and can achieve the same technical effect. To avoid repetition, it will not be described here.

In addition, as shown in FIG. 11, an embodiment of the present disclosure further provides a communication device 100, including a processor 101 and a memory 102, and the memory 102 stores a program or instruction that can be run on the processor 101. For example, when the communication device 100 is a first communication device, the program or instruction, when being executed by the processor 101, implements the various steps of the method embodiment shown in FIG. 1, and can achieve the same technical effect. When the communication device 100 is a second communication device, the program or instruction, when being executed by the processor 101, implements the various steps of the method embodiment shown in FIG. 2, or implements the various steps of the method embodiment shown in FIG. 3, and can achieve the same technical effect. When the communication device 100 is a seventh communication device, the program or instruction, when being executed by the processor 101, implements the various steps of the method embodiment shown in FIG. 3, and can achieve the same technical effect. When the communication device 100 is a fifth communication device, the program or instruction, when being executed by the processor 101, implements the various steps of the method embodiment shown in FIG. 4, and can achieve the same technical effect. To avoid redundancy, repeated description thereof is omitted here.

An embodiment of the present disclosure further provides a readable storage medium on which a program or instruction is stored. When the program or instruction is executed by a processor, the various processes of the above-mentioned session control method embodiment or the various processes of the above-mentioned charging method embodiment can be implemented, and the same technical effect can be achieved. To avoid redundancy, repeated description thereof is omitted here.

Computer-readable media include persistent and non-persistent, removable and non-removable media, and information storage can be achieved by any method or technology. Information can be computer-readable instructions, data structures, program modules or other data. Examples of computer storage media include, but are not limited to, Phase-Change Random Access Memory (PRAM), Static Random-Access Memory (SRAM), Dynamic Random Access Memory (DRAM), other types of Random Access Memory (RAM), Read-Only Memory (ROM), Electrically Erasable Programmable read only memory (EEPROM), flash memory or other memory technology, Compact Disc Read-Only Memory (CD-ROM), Digital Video Disc (DVD) or other optical storage, magnetic cassettes, magnetic tapes, magnetic disk storage or other magnetic storage devices or any other non-transmission media that can be used to store information accessible by a computing device. As defined herein, computer-readable media do not include transitory media such as modulated data signals and carrier waves.

It should be noted that, the terms “include”, “comprise” or any other variations thereof are intended to cover non-exclusive inclusion, so that a process, method, article or device including a series of elements includes not only those elements, but also other elements not explicitly listed, or also includes elements inherent to such process, method, article or device. In the absence of further restrictions, an element defined by the sentence “includes a . . . ” does not exclude the existence of other identical elements in the process, method, article or device including the element.

The serial numbers of the embodiments of the present disclosure are only for description and do not represent a preference.

Through the description of the above implementations, those skilled in the art can clearly understand that the above-mentioned embodiment methods can be implemented by means of software plus a necessary general hardware platform, and can be implemented by hardware as well, but in many cases the former is a better implementation method. Based on such an understanding, the technical solution of the present disclosure, or the part that contributes to the related art, can be embodied in the form of a software product, which is stored in a storage medium (such as ROM/RAM, a magnetic disk, or an optical disc), and includes a number of instructions for enabling a service classification device (which can be a mobile phone, a computer, a server, an air conditioner, or a network device, etc.) to execute the methods described in the embodiments of the present disclosure.

The above merely describes optional embodiments of the present disclosure. It should be pointed out that for those of ordinary skill in the art, several improvements and modifications can be made without departing from the principle of the present disclosure. These improvements and modifications should also be regarded as falling in the scope of the present disclosure.

1. A session control method, performed by a first communication device, comprising:
sending a first request message to a second communication device, wherein the first request message comprises one or more non-public network identifiers, and is used for requesting updating a number-of-sessions for each of the one or more non-public network identifiers;
receiving a first response message from the second communication device, wherein the first response message comprises first indication information, the first indication information is used for indicating whether the number-of-sessions for each of the one or more non-public network identifiers reaches a corresponding first value.

2. The method according to claim 1, wherein the first value is a maximum number-of-sessions for the corresponding non-public network identifier.

3. The method according to claim 1, wherein before sending the first request message to the second communication device, the method further comprises:
receiving a second request message from a third communication device, wherein the second request message is used for requesting at least one of the following: establishing a protocol data unit (PDU) session, releasing a PDU session, or modifying a PDU session.

4. The method according to claim 3, wherein, in a case that the second request message is used for requesting establishing the PDU session, and after receiving the first response message from the second communication device, the method further comprises:
in a case that the first indication information indicates that the number-of-sessions for at least one of the one or more non-public network identifiers does not reach the corresponding first value, sending a second response message to the third communication device, wherein the second response message is used for indicating that the request for establishing the PDU session is accepted;
or,
in a case that the first indication information indicates that the number-of-sessions for each of the one or more non-public network identifiers reaches the corresponding first value, sending a third response message to the third communication device, wherein the third response message is used for indicating that the request for establishing the PDU session is rejected.

5. The method according to claim 4, wherein the third response message comprises a cause value, and the cause value is used for indicating that a reason for rejecting the request for establishing the PDU session is that the numbers of sessions for the one or more non-public network identifiers all reach corresponding first values.

6. The method according to claim 1, further comprising:
in a case that the number-of-sessions for each of the one or more non-public network identifiers reaches the corresponding first value, rejecting a subsequent PDU session establishment request message for establishing a PDU session to any one of the one or more non-public networks corresponding to the one or more non-public network identifiers respectively;
or,
wherein, in a case that the number-of-sessions for each of the one or more non-public network identifiers reaches the corresponding first value, the first response message further comprises notification information, and the notification information is used for notifying the first communication device that a subsequent PDU session establishment request message for establishing a PDU session to any one of the one or more non-public networks corresponding to the one or more non-public network identifiers respectively is to be rejected;
or, p1 wherein, in a case that the first indication information indicates that the number-of-sessions for a second non-public network identifier reaches the corresponding first value, the second non-public network identifier being any one of the one or more non-public network identifiers, the method further comprises:
sending a subscription request to the second communication device, the subscription request being used for requesting the second communication device to notify the first communication device when the number-of-sessions for the second non-public network identifier is less than the corresponding first value; and
receiving a notification message from the second communication device when the number-of-sessions for the second non-public network identifier is less than the corresponding first value, wherein the notification message is used for notifying that the number-of-sessions for the second non-public network identifier is less than the corresponding first value.

7-8. (canceled)

9. The method according to claim 1, wherein, in a case that the first communication device is a session management function (SMF), each of the one or more non-public network identifiers is received by the SMF from an access mobility management function (AMF), and each of the one or more non-public network identifiers is determined by the AMF based on at least one of the following: terminal subscription data obtained from a fourth communication device, a non-public network identifier notified or indicated by a radio access network, or a list of non-public network identifiers notified or indicated by the radio access network;
or,
in a case that the first communication device is the AMF, each of the one or more non-public network identifiers is determined by the AMF based on at least one of the following: terminal subscription data obtained from the fourth communication device, a non-public network identifier notified or indicated by the radio access network, or a list of non-public network identifiers notified or indicated by the radio access network;
or
wherein the first request message further comprises at least one of the following:
a terminal identifier, or second indication information; wherein the second indication information is used for indicating that the number-of-sessions for each of the one or more non-public network identifiers is to be increased or decreased;
or,
wherein the one or more non-public network identifiers comprise at least one of the following:
one or more closed access group (CAG) identifiers (IDs);
one or more network identifiers (NIDs); or
one or more public land mobile network identifiers (PLMN IDs).

10-11. (canceled)

12. A session control method, performed by a second communication device, comprising:
receiving a first request message from a first communication device, wherein the first request message comprises one or more non-public network identifiers and is used for requesting updating a number-of-sessions for each of the one or more non-public network identifiers;
checking whether the number-of-sessions for each of the one or more non-public network identifiers reaches a corresponding first value, and updating the number-of-sessions for the non-public network identifier that does not reach the corresponding first value; and
sending a first response message to the first communication device, wherein the first response message comprises first indication information, wherein the first indication information is used for indicating whether the number-of-sessions for each of the one or more non-public network identifiers reaches the corresponding first value.

13. The method according to claim 12, wherein the first value is a maximum number-of-sessions for the corresponding non-public network identifier.

14. The method according to claim 12, wherein, in a case that the number-of-sessions for each of the one or more non-public network identifiers reaches the corresponding first value, the first response message further comprises notification information, and the notification information is used for notifying the first communication device that a subsequent PDU session establishment request message for establishing a PDU session to any one of the one or more non-public networks corresponding to the one or more non-public network identifiers respectively is to be rejected.

15. The method according to claim 12, wherein in a case that the first indication information indicates that the number-of-sessions for a second non-public network identifier reaches the corresponding first value, the second non-public network identifier being any one of the one or more non-public network identifiers, the method further comprises:
receiving a subscription request from the first communication device, the subscription request being used for requesting the second communication device to notify the first communication device when the number-of-sessions for the second non-public network identifier is less than the corresponding first value; and
sending a notification message to the first communication device when the number-of-sessions for the second non-public network identifier is less than the corresponding first value, wherein the notification message is used for notifying that the number-of-sessions for the second non-public network identifier is less than the corresponding first value.

16. The method according to claim 12, further comprising:
in a case that the number-of-sessions for a first non-public network identifier reaches the corresponding first value or a second value, sending a third request message to a fifth communication device, the third request message being used for reporting the number-of-sessions for the first non-public network identifier to enable the fifth communication device to perform a charging processing based on the number-of-sessions for the first non-public network identifier, the first non-public network identifier being any one of the one or more non-public network identifiers, the first value being the maximum number-of-sessions for the first non-public network identifier, the first value being greater than the second value, and the second value being any one of thresholds of number-of-sessions for the first non-public network identifier; and
receiving a fourth response message from the fifth communication device.

17. The method according to claim 16, wherein the third request message comprises at least one of the following:
the first non-public network identifier; or
the number-of-sessions for the first non-public network identifier.

18. The method according to claim 12, further comprising at least one of the following:
configuring a maximum number-of-sessions for each of the one or more non-public network identifiers and/or at least one threshold of number-of-sessions under the maximum number-of-sessions; or
obtaining, according to each of the one or more non-public network identifiers, the maximum number-of-sessions for each of the one or more non-public network identifiers and/or the at least one threshold of number-of-sessions under the maximum number-of-sessions from a sixth communication device;
or,
wherein the one or more non-public network identifiers comprise at least one of the following:
one or more closed access group (CAG) identifiers (IDs);
one or more network identifiers (NIDs); or
one or more public land mobile network identifiers (PLMN IDs).

19. (canceled)

20. A charging method, performed by a seventh communication device, comprising:
in a case that a number-of-sessions for a first non-public network identifier reaches a corresponding first value or a second value, sending a third request message to a fifth communication device, the third request message being used for reporting the number-of-sessions for the first non-public network identifier to enable the fifth communication device to perform a charging processing based on the number-of-sessions for the first non-public network identifier, the first value being a maximum number-of-sessions for the first non-public network identifier, the first value being greater than the second value, and the second value being any one of thresholds of number-of-sessions for the first non-public network identifier; and
receiving a fourth response message from the fifth communication device.

21. The method according to claim 20, wherein the third request message comprises at least one of the following:
the first non-public network identifier; or
the number-of-sessions for the first non-public network identifier.

22. The method according to claim 20, further comprising at least one of the following:
configuring a maximum number-of-sessions for each of the one or more non-public network identifiers and/or at least one threshold of number-of-sessions under the maximum number-of-sessions; or,
obtaining, according to each of the one or more non-public network identifiers, the maximum number-of-sessions for each of the one or more non-public network identifiers and/or the at least one threshold of number-of-sessions under the maximum number-of-sessions from a sixth communication device.

23-29. (canceled)

30. A communication device, comprising a processor, a memory, and a program or instruction stored in the memory and executable on the processor, wherein the program or instruction, when executed by the processor, implements the steps of the session control method according to claim 1.

31. (canceled)

32. A communication device, comprising a processor, a memory, and a program or instruction stored in the memory and executable on the processor, wherein the program or instruction, when executed by the processor, implements the steps of the session control method according to claim 12.

33. A communication device, comprising a processor, a memory, and a program or instruction stored in the memory and executable on the processor, wherein the program or instruction, when executed by the processor, implements the steps of the charging method according to claim 20.
